(19) United States
(12) Patent Application Publication
(10) Pub. No.: US 2011/0195627 A1
(43) Pub. Date: Aug. 11, 2011

(54) NATURAL RENEWABLE FIBER TRIM LAMINATE

(75) Inventors: Ashford Allen Galbreath, Troy, MI (US); Pusheng Chen, Novi, MI (US); Asad S. Ali, Troy, MI (US)

(73) Assignee: LEAR CORPORATION, Southfield, MI (US)

(21) Appl. No.: 13/062,799

(22) PCT Filed: Oct. 22, 2008
(86) PCT No.: PCT/US2008/080725

§ 371 Date: Mar. 8, 2011

(51) Int. Cl. A47C 27/22; B60N 2/58; A47C 27/15

(52) U.S. Cl. 442/181; 428/532; 428/480; 428/475.5; 428/492; 428/500; 428/318.4; 442/327; 428/473; 428/319.3; 428/319.9; 428/319.7

(57) ABSTRACT

A deformable structure for automotive interior components includes a substrate and a cushion element. The cushion element is disposed over the substrate. The cushion element includes a fiber section which has cellulosic fibers. The deformable structure also includes a cover disposed over the cushion element. A vehicle seat and trim laminate incorporating the deformable structure is also provided.

### BACKGROUND OF THE INVENTION

1. Field of the Invention

The present invention relates to a deformable structure that is useful in automotive interior applications.

2. Background Art

Automobile manufacturers and suppliers constantly strive to improve the aesthetic appeal of vehicle interior components. Such considerations have influenced the design of vehicle interior trim, seat, and console components to name a few. Environmental concerns place additional manufacturing pressures on vehicle design with renewable component be of paramount importance.

Many automobile interior components include resinous foams such as polyurethane. In a typical interior application an interior component will include a foam over a suitable frame or backing. Such resinous foams are found in vehicle trim laminates, vehicle seats, head restraints, armrests, dashboards, and the like. These foams function to provide cushioning or a soft feel to the interior component which is desirable by consumers. Although these foams work reasonably well, they are not easily recycled or biodegraded.

Accordingly, there is a need for improved automobile components that provide a cushioning effect while being at least partially recyclable.

### SUMMARY OF THE INVENTION

The present invention solve one or more problems of the prior art by providing in at least one embodiment a cushion element for automotive interior components. The cushion element includes a fiber section which has cellulosic fibers and a foam section. Advantageously, at least a portion of the fiber section is recyclable and derived from a renewable source.

In another embodiment of the present invention, a deformable structure for automotive interior components is provided. The deformable structure of the present embodiment incorporates the cushion element set forth above. The deformable structure comprises a substrate and the cushion element. The cushion element is positioned over the substrate. The cushion element includes a fiber section which has cellulosic fibers. The deformable structure also includes a cover disposed over the cushion element. Advantageously, at least a portion of the fiber section is recyclable and derived from a renewable source.

### BRIEF DESCRIPTION OF THE DRAWINGS

FIG. 1 is an exposed perspective view of a deformable structure incorporating renewable fibers;

FIG. 2A is a cross section of a variation of a deformable structure in which a fiber pad covers a foamed section;

FIG. 2B is a cross section of a variation of a deformable structure in which a fiber pad covers edge portions of a foamed section;

FIG. 2C is a cross section of a variation of a deformable structure in which a fiber pad covers a portion of a foamed section; and

FIG. 3 is an exposed perspective view of a vehicle seat having a renewable fiber pad disposed over a foam component.

### DETAILED DESCRIPTION OF THE PREFERRED EMBODIMENT(S)

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

The term “caliper thickness” as used herein means the perpendicular separation between the two surfaces of a sheet.

In an embodiment of the present invention, a deformable structure for use in a number of different automotive interior components. The deformable structure comprises a substrate and a cushion element. The cushion element is disposed over the substrate. The deformable structure is advantageously incorporated in head restraints, vehicle seats, armrests, dashboard, vehicle trim panels, and other trim laminates. As set forth in the background section, prior art versions of such structures generally includes a foam (e.g., polyurethane foam) to provide cushioning properties. The cushion element of the present embodiment entirely replaces or replaces a portion of these foams as set forth below in more detail.

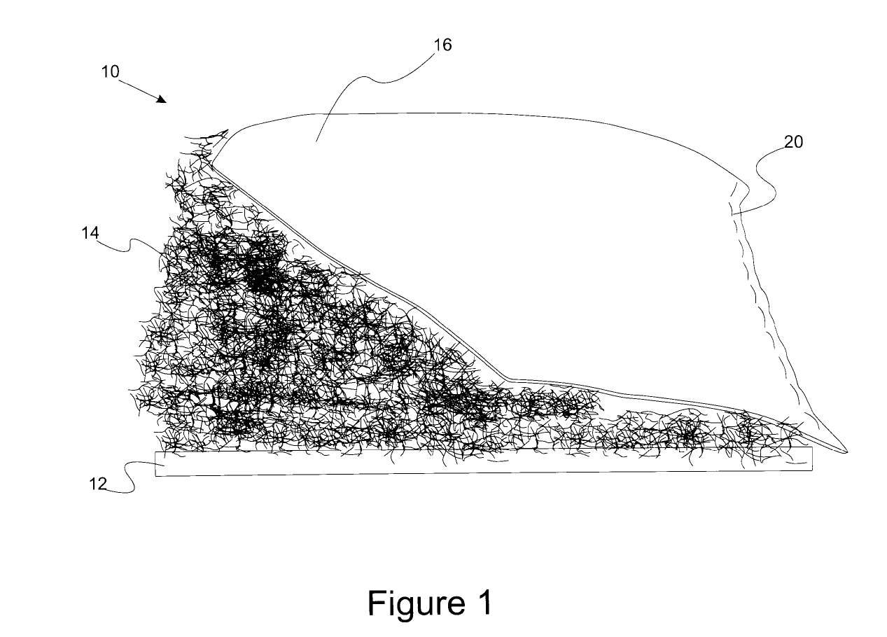

With reference to FIG. 1, an exposed perspective view of an embodiment of a deformable structure for automotive interior applications is provided. Deformable structure 10 includes foam substrate 12 and fibrous cushion 14. Fibrous cushion 14. includes cellulosic fibers. In other variation, fibrous cushion 14 includes additional cushion components such as additional foamed sections. Advantageously, at least a portion of fibrous cushion 14 is recyclable and derived from a renewable source. Examples of a renewable source are fast growth pine trees. This source of materials is to be contrasted to petroleum-derived raw materials used in polyurethane trim laminates and foam cushion inserts.

Still referring to FIG. 1, cover 16 is disposed over fibrous cushion 14. Cover 16 acts to secure cushion element in place while providing an aesthetically pleasing appearance and feel. Cover 16 is formed from any suitable material used in vehicle interior applications. Examples of such materials include, but are not limited to, non-woven fabrics, woven fabrics, leather, plastic sheets, vinyl sheets, and combinations thereof. In a variation, cover 16 is secured to substrate 12. FIG. 1 depicts an example in which cover 16 is stitched in place via stitching 20.

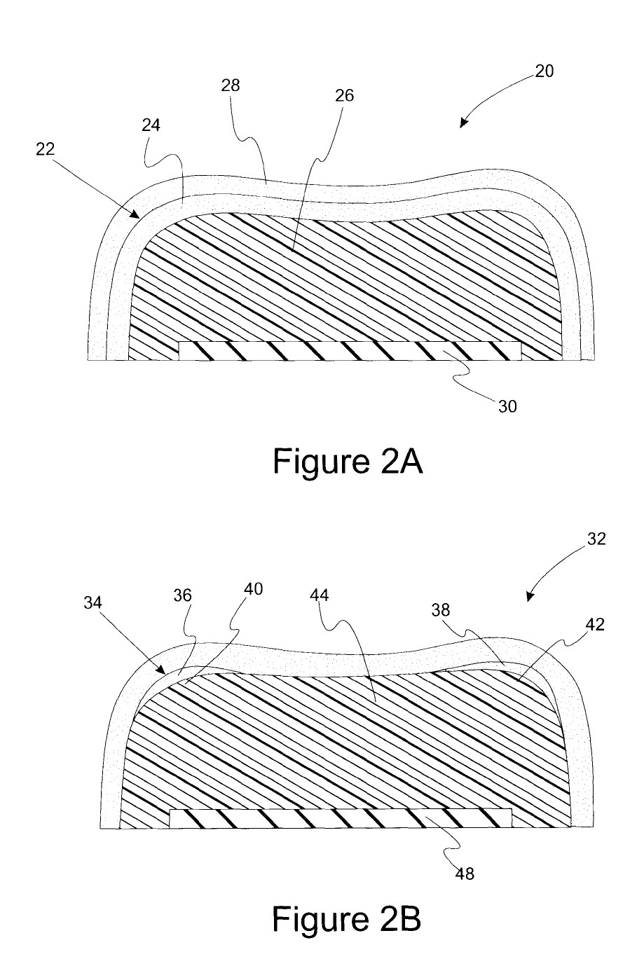

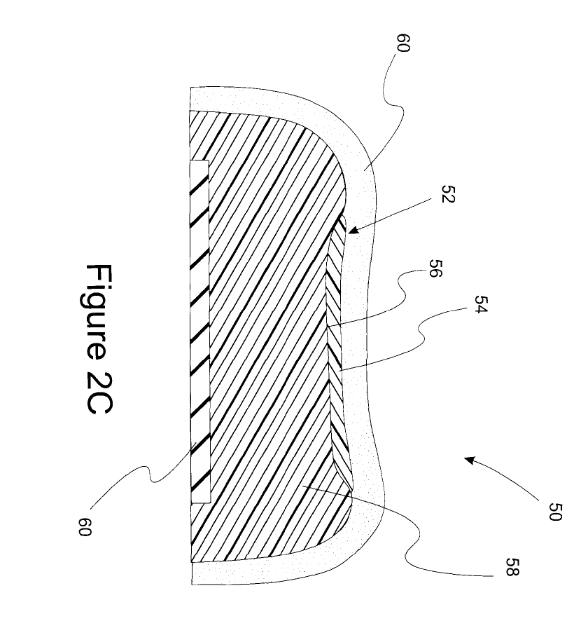

With reference to FIG. 2A, a schematic cross section of a fiber pad positioned over a foam cushion is provided. In this variation, deformable structure 20 includes cushion element 22. In this variation, cushion element 22 is a multi-component structure including at least a fiber section and a foamed section. Cushion element 22 includes fibrous pad 24 which is the fiber section. Fibrous pad 24 covers at least a portion of foam section 26. Pad 24 includes a mixture of cellulose fibers and synthetic fibers. As set forth above, cover 28 is positioned over cushion element 22. Finally, cushion element 22 is optionally positioned over substrate 30. For example, substrate 30 may be a part of a head restraint or seat frame or a backing for a trim laminate.

With reference to FIG. 2B, a schematic cross section of several fiber pads positioned over a sections of a foam cushion is provided. In this variation, deformable structure 32 includes cushion element 34. Cushion element 34 includes fibrous pads 36, 38 which covers portions 40, 42 of foam section 44. As set forth above, cover 46 is positioned over cushion element 34. Finally, cushion element 34 is optionally positioned over substrate 48. For example, substrate 48 may be a part of a head restraint or seat frame or a backing for a trim laminate.

With reference to FIG. 2C, a schematic cross section of a fiber pads positioned over a section of a foam cushion is provided. In this variation, deformable structure 50 includes cushion element 52. Cushion element 52 includes fibrous pad 54 which covers portion 56 of foam section 58. As set forth above, cover 60 is positioned over cushion element 52. As set forth above, cushion element 52 is optionally positioned over substrate 60.

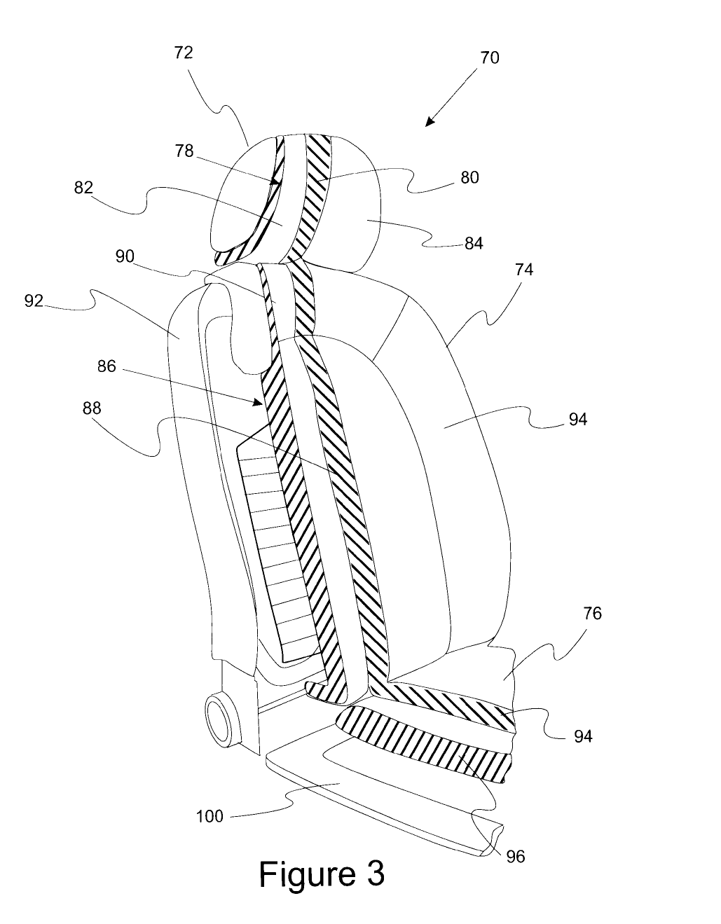

With reference to FIG. 3, a perspective view of a vehicle seat incorporating a cellulose-containing fiber layer is provided. Vehicle seat 70 includes head restraint 72, vehicle seat back 74 and vehicle seat bottom 76. Head restraint 72 includes cushion element 78. Cushion element 78 includes fibrous layer 80 positioned over cushion 82. Cover 84 over lays fibrous layer 80. Vehicle seat back 74 includes seat back cushion element 86 which includes and fibrous pad 88 positioned over foam cushion 90. Foam cushion 90 overlays seat back frame 92 while cover 94 overlays fibrous pad 88. Fibrous pad 80 includes cellulose fibers as set forth above. Similarly, vehicle seat bottom 76 includes fibrous pad 94 positioned over foam seat cushion 96. Foam seat cushion 96 is positioned over seat bottom frame 100.

As set forth above, embodiments of the present invention include a fiber section (i.e., fibrous pads, fibrous cushions, etc) which include cellulose fibers. U.S. patent application no. 20080050565 provides examples of useful materials for the fiber section. The entire disclosure of this patent application is hereby incorporated by reference. Examples of useful cellulose fibers include, but are not limited to, cellulose acetate and regenerated cellulose (e.g., viscose rayon).

In a variation of the present embodiment, the cellulose fibers are blended with synthetic fibers. Examples of useful synthetic fibers include, but are not limited to, polyester fibers, nylon fibers, latex fibers, polyethylene, fibers, polypropylene fibers, and combinations thereof. In a refinement, the cellulosic fibers and the synthetic fibers are present in a combined amount ranging from about 30 weight percent to about 95 weight percent based on the total weight of the fiber section. In another refinement, the cellulosic fibers and the synthetic fibers are present in a combined amount ranging from about 40 weight percent to about 60 weight percent based on the total weight of the fiber section.

In a variation of the present embodiment, the fibrous sections set forth above have a caliper thickness of from about 1.0 mm to about 60 mm. In a further refinement, the fibrous sections set forth above has a caliper thickness of from about 1.0 mm to about 20 mm. In still a further refinement, the fibrous sections set forth above has a caliper thickness of from about 1.0 mm to about 3 mm.

In a variation of the present embodiment, the cellulosic and natural fibers are characterized by a denier from about 1.0 dpf to about 4.0 1.5 dpf to about 2.5 dpf. In still another refinement, the cellulosic and natural fibers each independently have a length from about 3 mm to about 12 mm. In yet another refinement, the cellulosic and natural fibers each independently have a length from about 4.5 mm to about 7.5 mm.

In a variation of the present embodiment, the fibrous sections set forth above have a density from about 30 kg/m³ to about 50 kg/m³. In a further refinement, the fibrous sections set forth above have a density from about 35 kg/m³ to about 45 kg/m³. In still a further refinement, the fibrous sections set forth above have a density from about 37 kg/m³ to about 43 kg/m³.

In a variation of the present embodiment, the fiber section set forth above includes a binder. Examples of suitable binders include, but are not limited to, bicomponent fiber binders, latex binders, thermoplastic materials, and combinations thereof. In a refinement, the binder is present in amounts ranging from about 5 weight percent to about 70 weight percent of the total weight of the fiber section. In another refinement, the binder is present in amounts ranging from about 20 weight percent to about 40 weight percent of the total weight of the fiber section.

In another variation of the present embodiment, the fiber section further comprises a fire retardant. Examples of suitable fire retardants include, but are not limited to, sodium borate, sodium or ammonium phosphates, phosphate esters, diammonium phosphate based flame retardants, sodium tetraborate decahydrate, and combinations thereof.

While embodiments of the invention have been illustrated and described, it is not intended that these embodiments illustrate and describe all possible forms of the invention. Rather, the words used in the specification are words for description rather than limitation, and it is understood that various changes may be made without departing from the spirit and scope of the invention.

What is claimed:

1. A deformable structure comprising:
a substrate;
a cushion element disposed over the substrate, the cushion element including a fiber section comprising cellulosic fibers; and
a cover disposed over the cushion element.

2. The deformable structure of claim 1 wherein the fiber section further comprising synthetic fibers.

3. The deformable structure of claim 2 wherein the synthetic fibers comprise a component selected from the group consisting of polyester fibers, nylon fibers, latex fibers, polyethylene fibers, polypropylene fibers, and combinations thereof.

4. The deformable structure of claim 1 wherein the cellulosic fibers and the synthetic fibers are present in a combined amount ranging from about 30 weight percent to about 95 weight percent based on the total weight of the fiber section.

5. The deformable structure of claim 1 wherein the fiber section further comprises a binder.

6. The deformable structure of claim 5 wherein the binder is present in an amount from about 5 weight percent to about 70 weight percent of the total weight of the fiber section.

7. The deformable structure of claim 5 wherein the binder comprises a component selected from the group consisting of bicomponent fiber binders, latex binders, thermoplastic materials, and combinations thereof.

8. The deformable structure of claim 4 wherein the cushion section is a seat cushion.

9. The deformable structure of claim 8 wherein the cushion element is further includes a foam section.

10. The deformable structure of claim 9 wherein the fiber section is a pad covering a surface of the foam section.

11. The deformable structure of claim 9 wherein the cushion element is adapted to be placed in a seat.

12. The deformable structure of claim 1 wherein the cover comprises a component selected from the group consisting of a non-woven fabric, a woven fabric, leather, a plastic sheet and combinations thereof.

13. A trim laminate comprising the deformable structure of claim 1.

14. A cushion element for automotive interior components, the cushion element comprising:
a fiber section comprising cellulosic fibers; and
a foam section contacting the fiber section.

15. The cushion element of claim 14 wherein the fiber section further comprising synthetic fibers.

16. The cushion element of claim 15 wherein the synthetic fibers comprise a component selected from the group consisting of polyester fibers, nylon fibers, latex fibers, polyethylene fibers, polypropylene fibers, and combinations thereof.

17. The cushion element of claim 14 wherein the cellulosic fibers and the synthetic fibers are present in a combined amount ranging from about 30 weight percent to about 95 weight percent based on the total weight of the fiber section.

18. The cushion element of claim 14 wherein the fiber section further comprises a binder.

19. The cushion element of claim 18 wherein the binder comprises a component selected from the group consisting of bicomponent fiber binders, latex binders, thermoplastic materials, and combinations thereof.

20. A deformable structure comprising:
a cushion element including:
a foam cushion;
a fibrous pad disposed over a portion of the foam cushion, the fibrous pad comprising cellulosic fibers; and
a cover disposed over the cushion element.
